(19) United States
(12) Patent Application Publication
(10) Pub. No.: US 2026/0243202 A1
(43) Pub. Date: Aug. 20, 2026

(54) GAS TURBINE DEVICE AND METHOD FOR OPERATING GAS TURBINE DEVICE

(71) Applicant: MITSUBISHI HEAVY INDUSTRIES, LTD., Tokyo (JP)

(72) Inventors: Shigetaro MIYAHARA, Tokyo (JP); Masahiko NAKAHARA, Tokyo (JP)

(21) Appl. No.: 19/157,539

(22) PCT Filed: Feb. 22, 2024
(86) PCT No.: PCT/JP2024/006485

§ 371 Date: Aug. 18, 2025

(30) Foreign Application Priority Data
Mar. 9, 2023 (JP) 2023-036107

(51) Int. Cl. F02C 9/18; F02C 3/22; F02C 7/18; F02C 7/22

(52) U.S. Cl. CPC F02C 9/18; F02C 3/22; F02C 7/18; F02C 7/22; F05D 2240/35; F05D 2260/232; F05D 2260/607

(57) ABSTRACT

This gas turbine device comprises a combustor casing to which compressed air from a gas turbine compressor is guided, a combustor which is provided in the combustor casing and which includes a gas nozzle for injecting gaseous fuel and an oil nozzle for ejecting oil fuel, a first purge air line configured to supply first air derived from bleed air from the combustor casing to the oil nozzle, and a second purge air line configured to supply second air compressed by an external compressor separate from the gas turbine compressor to the oil nozzle, the gas turbine device being configured to be capable of selectively supplying the first air from the first purge air line and the second air from the second purge air line as purge air to the oil nozzle.

### TECHNICAL FIELD

The present disclosure relates to a gas turbine device and a method for operating a gas turbine device.

### BACKGROUND ART

In order to prevent a fuel nozzle of a gas turbine combustor from being burn-damaged due to an intake of combustion gas or the like, purge air may be supplied to the fuel nozzle.

The present application claims priority based on Japanese Patent Application No. 2023-036107 filed in Japan on Mar. 9, 2023, the contents of which are incorporated herein by reference.

For example, in PTL 1, in a gas turbine including a dual-fuel firing combustor that performs combustion by selectively using fuel gas and a fuel oil as a fuel, in order to prevent a pilot nozzle (fuel gas injection nozzle) that does not inject the fuel gas as the fuel during an oil firing operation from being burn-damaged, it is described that sweep air such as compressed air introduced from a casing of the gas turbine is supplied to the pilot nozzle.

### CITATION LIST

### Patent Literature

[PTL 1] International Publication No. WO2012/057282

### SUMMARY OF INVENTION

### Technical Problem

In the dual-fuel firing gas turbine, in order to suppress burn damage of the nozzle for oil fuel injection (hereinafter, an oil nozzle) due to the intake of the combustion gas or the like when the oil fuel is not used, or the like, and in order to remove the oil remaining in the oil nozzle when the supply of the oil fuel is stopped, purge air may be supplied to the oil nozzle. In order to remove the oil remaining in the oil nozzle, particularly high-pressure purge air is required. Therefore, in the related art, high-pressure air compressed by a compressor different from a gas turbine compressor (a compressor that generates compressed air supplied to a combustor) is used as the purge air. As a compressor for generating the high-pressure purge air, a positive-displacement compressor having a high compression ratio is usually adopted.

However, the positive-displacement compressor has a higher failure rate than a turbo compressor, so that a maintenance frequency increases, and in a case of failure, it is necessary to stop the gas turbine in order to prevent the oil nozzle from being burn-damaged.

In view of the above circumstances, an object of at least one embodiment of the present invention is to provide a gas turbine device and a method for operating a gas turbine device that can effectively suppress damage to gas turbine components while reducing maintenance costs.

### Solution to Problem

According to at least one embodiment of the present invention, there is provided a gas turbine device including:
a combustor casing to which compressed air from a gas turbine compressor is guided;
a combustor provided in the combustor casing and including a gas nozzle for injecting a gaseous fuel and an oil nozzle for ejecting an oil fuel;
a first purge-air line configured to supply first air derived from bleed air from the combustor casing to the oil nozzle; and
a second purge-air line configured to supply second air compressed by an external compressor different from the gas turbine compressor to the oil nozzle,
in which the gas turbine device is configured to selectively supply either the first air from the first purge-air line or the second air from the second purge-air line to the oil nozzle as purge air.

In addition, a method for operating a gas turbine device according to at least one embodiment of the present invention is a method for operating a gas turbine device including a combustor casing to which compressed air from a gas turbine compressor is guided, a combustor provided in the combustor casing and including a gas nozzle for injecting a gaseous fuel and an oil nozzle for ejecting an oil fuel, a first purge-air line configured to supply first air derived from bleed air from the combustor casing to the oil nozzle, and a second purge-air line configured to supply second air compressed by an external compressor different from the gas turbine compressor to the oil nozzle, the method including:
a step of selectively supplying either the first air from the first purge-air line or the second air from the second purge-air line to the oil nozzle as purge air.

### Advantageous Effects of Invention

According to at least one embodiment of the present invention, there are provided a gas turbine device and a method for operating a gas turbine device that can effectively suppress damage to gas turbine components while reducing maintenance costs.

### BRIEF DESCRIPTION OF DRAWINGS

FIG. 1 is a schematic configuration diagram of a gas turbine device according to an embodiment.

FIG. 2 is a schematic sectional view of a combustor 4 of a gas turbine device 1 shown in FIG. 1.

FIG. 3 is a schematic diagram of a fuel nozzle of a gas turbine device according to an embodiment.

FIG. 4 is a schematic diagram showing an overall configuration of a gas turbine device 1 according to an embodiment.

### DESCRIPTION OF EMBODIMENTS

Hereinafter, some embodiments of the present invention will be described with reference to the accompanying drawings. Dimensions, materials, shapes, relative arrangements, and the like of components described as embodiments or shown in the drawings are not intended to limit the scope of the present invention, but are merely explanatory examples.

### Configuration of Gas Turbine Device

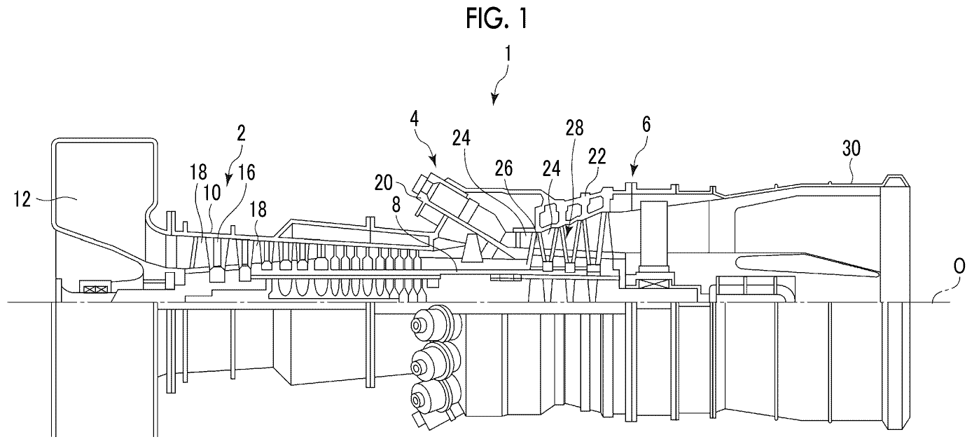

FIG. 1 is a schematic configuration diagram of a gas turbine device according to an embodiment. As shown in FIG. 1, a gas turbine device 1 includes a gas turbine compressor 2 for generating compressed air, a combustor 4 for generating combustion gas by using the compressed air and a fuel, and a turbine 6 configured to be rotationally driven by the combustion gas. In the case of the gas turbine device 1 for power generation, a generator (not shown) is connected to the turbine 6.

The gas turbine compressor 2 includes a plurality of stator vanes 16 fixed to the compressor casing 10 side, and a plurality of rotor blades 18 embedded in a rotor 8 to be alternately arranged with respect to the stator vanes 16. Air taken in through an air intake port 12 is sent to the gas turbine compressor 2, and the air passes through the plurality of stator vanes 16 and the plurality of rotor blades 18 and is compressed to become high-temperature and high-pressure compressed air.

The fuel and the compressed air generated by the gas turbine compressor 2 are supplied to the combustor 4, and the fuel is combusted in the combustor 4. In this manner, combustion gas serving as a working fluid of the turbine 6 is generated. As shown in FIG. 1, the gas turbine device 1 includes a plurality of combustors 4 disposed in a combustor casing (casing) 20 along a circumferential direction around the rotor 8 (rotor axis O).

The turbine 6 includes a combustion gas passage 28 formed by a turbine casing 22, and includes a plurality of stator vanes 24 and a plurality of rotor blades 26 provided in the combustion gas passage 28. The stator vanes 24 and the rotor blades 26 of the turbine 6 are provided downstream of the combustor 4 with respect to a flow of the combustion gas. The stator vanes 24 are fixed on the turbine casing 22 side, and a plurality of stator vanes 24 arranged along the circumferential direction of the rotor 8 constitute a stator vane row. In addition, the rotor blades 26 are embedded in the rotor 8, and a plurality of rotor blades 26 arranged along the circumferential direction of the rotor 8 constitute a rotor blade row. Stator vane rows and rotor blade rows are alternately arranged in an axial direction of the rotor 8.

In the turbine 6, the combustion gas from the combustor 4 that flows into the combustion gas passage 28 passes through the plurality of stator vanes 24 and the plurality of rotor blades 26, so that the rotor 8 is rotationally driven. Accordingly, a generator connected to the rotor 8 is driven to generate power. After the turbine 6 is driven, the combustion gas is discharged to an outside via an exhaust chamber 30.

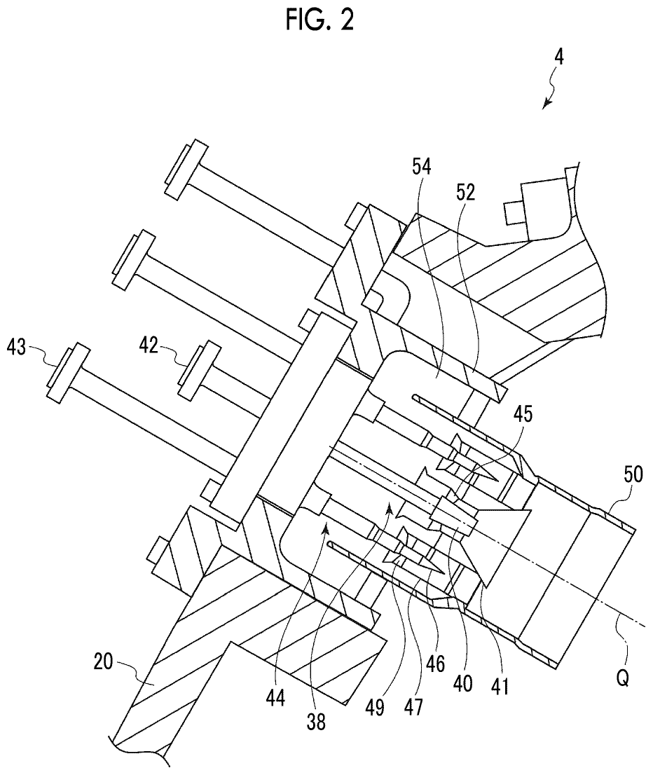

FIG. 2 is a schematic sectional view of the combustor 4 of the gas turbine device 1 shown in FIG. 1. As shown in FIG. 2, each of the combustors 4 (refer to FIG. 1) that are disposed in the circumferential direction around the rotor 8 includes a combustor liner 50 provided inside the combustor casing (casing) 20, a first combustion burner 38 disposed respectively inside the combustor liner 50, and a plurality of second combustion burners 44 disposed to surround the first combustion burner 38. That is, the combustor liner 50, the first combustion burner 38, and the second combustion burner 44 are accommodated in the combustor casing 20.

The first combustion burner 38 is disposed to extend along a central axis Q of the combustor liner 50, and includes a first fuel nozzle 40 for injecting fuel, and a first burner cylinder 41 disposed to surround the first fuel nozzle 40. The fuel is supplied to the first fuel nozzle 40 via a first fuel port 42.

The second combustion burner 44 has a second fuel nozzle 46 for injecting fuel and a second burner cylinder 47 disposed to surround the second fuel nozzle 46. The fuel is supplied to the second fuel nozzle 46 via a second fuel port 43.

The combustor 4 further includes an outer cylinder 52 provided on an outer peripheral side of the combustor liner 50 inside the combustor casing 20. An air passage 54 through which the compressed air flows is formed on an outer peripheral side of an inner cylinder 48 and an inner peripheral side of the outer cylinder 52.

Swirlers 45 and 49 are respectively provided around the first fuel nozzle 40 and the second fuel nozzle 46, and compressed air from the gas turbine compressor 2 (refer to FIG. 1) is supplied into the combustor liner 50 via the swirlers 45 and 49.

In the combustor 4 configured in this way, a mixed gas of fuel and air is formed in the combustor liner 50 by the fuel ejected from the fuel nozzles 40 and 46 and the compressed air supplied via the air passage 54 and the swirlers 45 and 49. The mixed gas flowing into the combustor liner 50 is ignited by either an ignition device (not shown) or a pilot flame, and thus combustion gas is generated. The combustion gas flows through the combustor liner 50 and is guided to the turbine 6 (refer to FIG. 1).

The first combustion burner 38 described above may be configured to form a pilot flame. That is, the first fuel nozzle 40 of the first combustion burner 38 may be a pilot nozzle for ejecting a pilot fuel for forming a pilot flame.

In some embodiments, the gas turbine device 1 is a gas turbine including the combustor 4 for dual-fuel firing capable of performing combustion by selectively using a gaseous fuel and an oil fuel as a fuel. That is, the combustor 4 for dual-fuel firing includes both a gas nozzle for ejecting a gaseous fuel and an oil nozzle for ejecting an oil fuel.

In the combustor 4 of dual-fuel firing, a single nozzle member may function as the gas nozzle and the oil nozzle. That is, a single nozzle member may be provided with a passage and an ejection hole for a gaseous fuel and a passage and an ejection hole for an oil fuel. Alternatively, in the combustor 4 of dual-fuel firing, a nozzle member functioning as a gas nozzle and a nozzle member functioning as an oil nozzle may be separately installed.

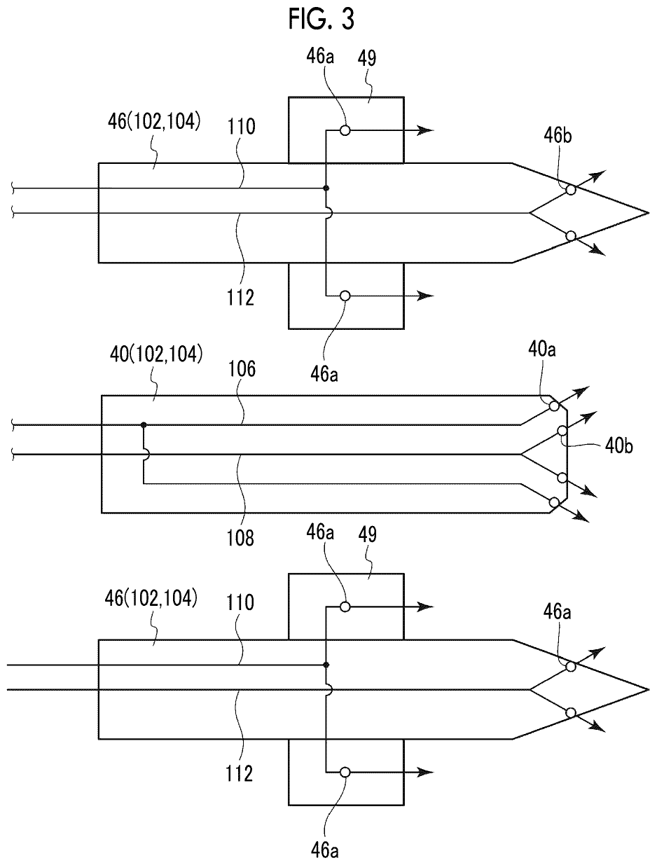

FIG. 3 is a schematic view of the fuel nozzles (the first fuel nozzle 40 and the second fuel nozzle 46) of the gas turbine device 1 according to the embodiment. The fuel nozzle shown in FIG. 3 is a fuel nozzle of the combustor 4 of dual-fuel firing. Each of the first fuel nozzle 40 and the second fuel nozzle 46 shown in FIG. 3 functions as a gas nozzle 102 and an oil nozzle 104.

The first fuel nozzle 40 shown in FIG. 3 is the gas nozzle 102 having a gaseous fuel passage 106 and a gaseous fuel ejecting hole 40a, and is the oil nozzle 104 having an oil fuel passage 108 and an oil fuel ejecting hole 40b. In addition, the second fuel nozzle 46 shown in FIG. 3 is the gas nozzle 102 having a gaseous fuel passage 110 and a gaseous fuel ejecting hole 46a, and is the oil nozzle 104 having an oil fuel passage 112 and an oil fuel ejecting hole 46b. Although not specifically shown, the gaseous fuel and the oil fuel are supplied from separate fuel ports.

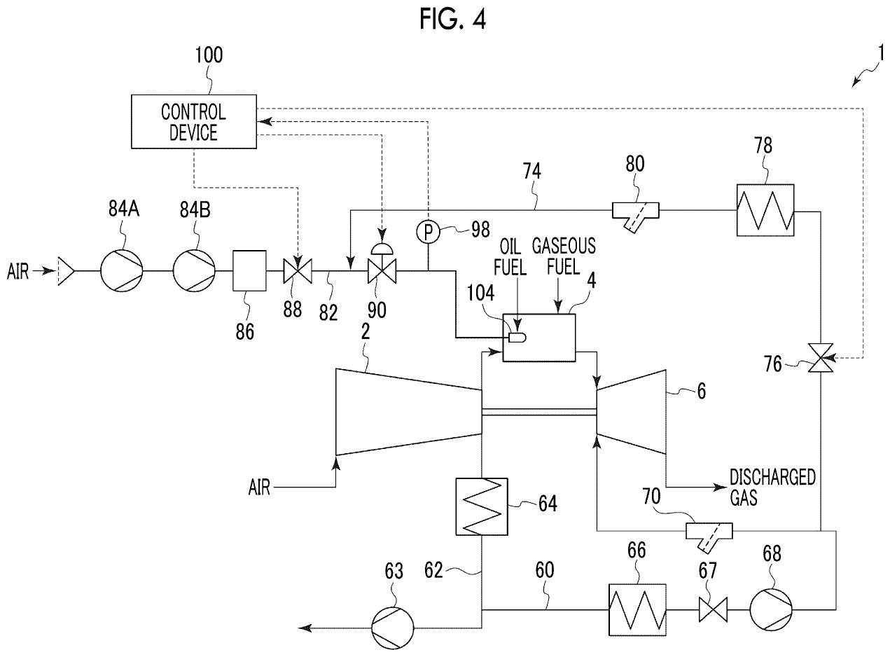

FIG. 4 is a schematic diagram showing an overall configuration of the gas turbine device 1 according to the embodiment. The gas turbine device 1 shown in FIG. 1 includes the gas turbine compressor 2, the combustor 4, and the turbine 6 described above. The combustor 4 is a dual-fuel firing combustor capable of performing combustion by selectively using a gaseous fuel and an oil fuel as a fuel, and includes both the gas nozzle 102 (not shown in FIG. 4) and the oil nozzle 104.

The gas turbine device 1 shown in FIG. 1 includes a first purge-air line 74 and a second purge-air line 82 for supplying purge air to the oil nozzle 104 of the combustor 4. Here, the oil nozzle 104 to which the purge air is supplied may be the first fuel nozzle 40 described above, or may be the second fuel nozzle 46 described above.

The first purge-air line 74 is configured to supply the first air derived from bleed air (that is, the air compressed by the gas turbine compressor 2) from the combustor casing 20 to the oil nozzle 104. In the exemplary embodiment shown in FIG. 4, the gas turbine device 1 includes a first bleed-air line 62 for air (that is, air at an outlet of the gas turbine compressor 2) from the combustor casing 20, and a second bleed-air line 60 that branches from the first bleed-air line 62. A portion of the air flowing through the first bleed-air line 62 is guided to the second bleed-air line 60. The first purge-air line 74 is provided to branch from the second bleed-air line 60, and is configured to guide air derived from the air (bleed air) flowing through the second bleed-air line 60. A downstream end of the first purge-air line 74 is connected to the second purge-air line 82. A filter 80 for removing foreign substances contained in the bleed air from the combustor casing 20 may be provided in the first purge-air line 74.

The second purge-air line 82 is configured to supply the second air compressed by an external compressor 84 different from the gas turbine compressor 2 to the oil nozzle 104. In the exemplary embodiment shown in FIG. 4, external compressors 84A and 84B are provided in the second purge-air line 82 and are connected to the oil nozzle 104. The external compressor 84 may include a positive-displacement compressor (a reciprocating compressor, a rotary compressor such as a screw compressor, or the like). As shown in FIG. 4, the second purge-air line 82 may be provided with an air receiver 86 capable of storing the air compressed by the external compressor 84.

As the purge air to the oil nozzle 104, the first air from the first purge-air line 74 and the second air from the second purge-air line 82 can be selectively supplied. In the exemplary embodiment shown in FIG. 4, the first purge-air line 74 is provided with a first valve 76 capable of switching a supply state of the first air from the first purge-air line 74 to the oil nozzle 104, and the second purge-air line 82 is provided with a second valve 88 capable of switching a supply state of the second air from the second purge-air line 92 to the oil nozzle 104. By appropriately opening and closing the first valve 76 and the second valve 88, the first air from the first purge-air line 74 and the second air from the second purge-air line 82 can be selectively supplied as the purge air to the oil nozzle 104.

In the exemplary embodiment shown in FIG. 4, in the second purge-air line 82, a pressure-regulating valve 90 for adjusting the pressure of the purge air supplied to the oil nozzle 104 is provided at a position downstream of the connection point of the first purge-air line 74. By adjusting an opening degree of the pressure-regulating valve 90, purge air having an appropriate pressure can be supplied to the oil nozzle 104.

In the gas turbine device 1 according to the above-described embodiment, the first air derived from the bleed air from the combustor casing 20 and the second air, which is the compressed air generated by the external compressor 84, can be selectively supplied as the purge air for suppressing burn damage of the oil nozzle 104 or for blowing off and removing a remaining oil of the oil nozzle 104. In a case where the oil fuel remains in the oil nozzle 104, there is a possibility that coking will occur. Therefore, it is desirable to remove the oil remaining in the oil nozzle 104.

Here, as the external compressor 84, a positive-displacement compressor having a high compression ratio and capable of easily generating a high-pressure gas is usually used. Since the positive-displacement compressor has a higher failure rate than a turbo compressor, a maintenance frequency increases, and in a case of failure, it is necessary to stop the gas turbine in order to prevent the oil nozzle from being burn-damaged.

In this regard, in the gas turbine device 1 according to the above-described embodiment, when the first air derived from the bleed air from the combustor casing 20 can be used as the purge air to the oil nozzle 104, the first air can be supplied instead of the second air generated by the external compressor 84. Accordingly, a frequency of use of the external compressor 84 can be reduced when the purge air is supplied to the oil nozzle 104. Therefore, the failure rate of the gas turbine components can be reduced. Therefore, according to the above-described embodiment, it is possible to effectively suppress damage to gas turbine components while reducing maintenance costs.

In some embodiments, a target of the supply of the purge air from the first purge-air line 74 and the second purge-air line 82 may be the first fuel nozzle 40 as the oil nozzle 104 provided to extend along the central axis Q of the combustor liner 50 of the combustor 4 (refer to FIGS. 2 and 3). Alternatively, in some embodiments, the target of the supply of the purge air from the first purge-air line 74 and the second purge-air line 82 may be an oil nozzle (for example, the first fuel nozzle 40 described above) that functions as a pilot nozzle.

The first fuel nozzle 40 (for example, a pilot nozzle or the like) serving as the oil nozzle 104 provided to extend along the central axis Q of the combustor liner 50 is located near a region where the fuel is combusted, compared to a nozzle (for example, the second fuel nozzle 46 serving as the oil nozzle 104) disposed in the vicinity of the first fuel nozzle 40. Therefore, there is a high risk of burn damage due to intake of high-temperature combustion gas. For this reason, it is highly necessary to supply the high-pressure purge air to the first fuel nozzle 40. In this regard, according to the above-described embodiment, the first air derived from the bleed air derived from the combustor casing 20 and the second air, which is the compressed air generated by the external compressor 84, can be selectively supplied to the first fuel nozzle 40 provided to extend along the central axis Q of the combustor liner 50, as the purge air to the oil nozzle 104. Therefore, it is possible to more effectively suppress damage to the gas turbine components while reducing maintenance costs.

In some embodiments, for example, as shown in FIG. 4, the gas turbine device 1 includes a bleed-air compressor 68 for boosting the bleed air from the combustor casing 20. In addition, the first purge-air line 74 is configured to supply the first air generated by compressing the bleed air with the bleed-air compressor 68 to the oil nozzle 104.

In the exemplary embodiment shown in FIG. 4, in the second bleed-air line 60 in which the first purge-air line 74 branches, the bleed-air compressor 68 is provided upstream of the branching point of the first purge-air line 74. The air boosted by the bleed-air compressor 68 is guided to the first purge-air line 74.

According to the above-described embodiment, the bleed air (air compressed by the gas turbine compressor 2) from the combustor casing 20 is further boosted by the bleed-air compressor 68. Therefore, the first air having a pressure (pressure higher than the pressure of the combustor casing 20) appropriate for the purge air for suppressing the combustion gas intake of the oil nozzle 104 can be generated. Therefore, when the first air derived from the bleed air from the combustor casing 20 can be used as the purge air (for example, when the pressure of the combustor casing 20 is equal to or higher than a predetermined value), the first air can be supplied as the purge air. Therefore, the frequency of use of the external compressor 84 when the purge air is supplied to the oil nozzle 104 can be reduced. Therefore, the failure rate of the gas turbine components can be reduced.

The above-described bleed-air compressor 68 may be a turbo compressor (for example, a centrifugal compressor, an axial compressor, or the like).

In this case, a turbo compressor that generally has a lower failure rate than a positive-displacement compressor is used as the bleed-air compressor 68. Therefore, when the first air derived from the bleed air from the combustor casing 20 can be used as the purge air, the first air compressed by the bleed-air compressor 68 is supplied as the purge air, so that the failure rate of the gas turbine components can be effectively reduced. Therefore, it is possible to effectively suppress damage to the gas turbine components while effectively reducing maintenance costs.

As shown in FIG. 4, a valve 67 for adjusting the amount of air flowing through the second bleed-air line 60 or for shutting off the flow of air in the second bleed-air line 60 may be provided.

In the exemplary embodiment shown in FIG. 4, a first bleed-air cooler 64 is provided in the first bleed-air line 62. The bleed air from the combustor casing 20 via the first bleed-air line 62 is cooled by the first bleed-air cooler 64 and is supplied to a rotating member (rotor disc (rotor 8) of the turbine 6, rotor blades 26, or the like) of the gas turbine device 1 as cooling air. A booster 63 for boosting the pressure of the cooling air may be provided in the first bleed-air line 62. The first bleed-air cooler 64, for example, may be configured to cool the air of the first bleed-air line 62 by exchanging heat with feed water of a steam turbine (not shown) driven by steam generated by utilizing the heat of discharged gas from the gas turbine device 1. The feed water may be heated by exchanging heat with the discharged gas from the gas turbine device 1 in a boiler (not shown).

The second bleed-air line 60 is provided to branch from the first bleed-air line 62 downstream of the first bleed-air cooler 64. The second bleed-air line 60 is configured to supply the air from the first bleed-air line 62 to stationary members (combustor 4, vane ring of the turbine 6, stator vane 26, or the like) of the gas turbine device 1 as cooling air.

The cooling air having a higher pressure than the cooling air supplied from the first bleed-air line 60 to the rotating member or the like may be supplied from the second bleed-air line 60 to the stationary members or the like of the gas turbine device 1. That is, the pressure at an outlet of the bleed-air compressor 68 in the second bleed-air line 60 may be higher than the pressure at an outlet of the booster 63 in the first bleed-air line 62. In this case, the higher-pressure cooling air can be supplied to the combustor 4 to which the high-pressure air from the gas turbine compressor 2 is supplied as the combustion air, and the combustor 4 can be easily and appropriately cooled.

As shown in FIG. 4, the second bleed-air line 60 may be provided with a second bleed-air cooler 66 for further cooling the air from the first bleed-air line 62. In addition, the second bleed-air line 60 may be provided with a filter 70 for removing foreign substances contained in the cooling air. The second bleed-air cooler 66 may be configured to cool the air of the second bleed-air line 60 by a condensate of a steam turbine (not shown) driven by steam generated by utilizing the heat of the discharged gas from the gas turbine device 1, for example, or by exchanging heat with atmospheric air. The condensate described above includes the condensed water generated by condensing the steam discharged from the steam turbine in the condenser.

The first purge-air line 74 is provided to branch from the second bleed-air line 60 downstream of the second bleed-air cooler 66. The first purge-air line 74 may be provided with a purge-air cooler 78 (cooler) for further cooling the air from the second bleed-air line 60. The purge-air cooler 78 may be configured to cool the air in the first purge-air line 74 by exchanging heat with water having a temperature equal to or lower than a normal temperature, for example.

In order to supply the bleed air from the combustor casing 20 to the combustor 4 or the like as cooling air, a compressor (bleed-air compressor 68) for making the pressure of the bleed air higher than the pressure of the combustor casing 20 is required. In the above-described embodiment, the first purge-air line 74 branches from the second bleed-air line 60 for supplying the bleed air from the combustor casing 20 to a stationary part such as the combustor 4 as the cooling air. Therefore, the air derived from the bleed air guided from the second bleed-air line 60 to the first purge-air line 74 is supplied to the oil nozzle 104 as the purge air. Therefore, the second bleed-air line 60 can be used for both the supply of the cooling air and the supply of the purge air to the oil nozzle 104, and an installation area of the equipment can be reduced as compared with a case where a bleed-air line for the purge air is installed separately from the second bleed-air line 60 for the cooling air.

In some embodiments, the gas turbine device 1 includes at least one cooler (for example, at least one of the first bleed-air cooler 64, the second bleed-air cooler 66, or the purge-air cooler 78 described above) for cooling the first air derived from the bleed air supplied to the oil nozzle 104 from the combustor casing 20 via the first purge-air line 74.

In the exemplary embodiment shown in FIG. 4, the gas turbine device 1 includes the first bleed-air cooler 64, the second bleed-air cooler 66, and the purge-air cooler 78 as the above-described cooler.

In some embodiments, for example, as shown in FIG. 4, the purge-air cooler 78 (cooler) for cooling the first air derived from the bleed air may be provided in the first purge-air line 74.

According to the above-described embodiment, the air that has flowed into the first purge-air line 74 from the second bleed-air line 60 through which the cooling air for cooling the combustor 4 flows can be further cooled by the purge-air cooler 78 provided in the first purge-air line 74. Therefore, by supplying the first air cooled in this way to the oil nozzle 104 as the purge air, it is possible to more effectively suppress the burn damage of the oil nozzle 104 due to the high-temperature combustion gas intake or the like.

In addition, in the exemplary embodiment shown in FIG. 4, the air from the first bleed-air line 62 and the second bleed-air line 60 for supplying the cooling air to the gas turbine device 1 is guided to the first purge-air line 74. Therefore, the air derived from the bleed air can be easily cooled to a temperature suitable for purge air to be supplied to the oil nozzle 104 by using the first bleed-air cooler 64 provided in the first bleed-air line 62 and the second bleed-air cooler 66 provided in the second bleed-air line 60.

In addition, in the exemplary embodiment shown in FIG. 4, the air from the first bleed-air line 62 and the second bleed-air line 60 for supplying the cooling air to the gas turbine device 1 is guided to the first purge-air line 74. Therefore, the air boosted by the bleed-air compressor 68 provided in the second bleed-air line 60 is cooled solely by the purge-air cooler 78, and thus the air can be used as the purge air to the oil nozzle 104.

As shown in FIG. 4, the downstream end of the first purge-air line 74 may be connected to the second purge-air line 82 downstream of the external compressor 84 (84A, 84B).

According to the above-described configuration, the downstream end of the first purge-air line 74 is connected to the second purge-air line 82 downstream of the external compressor 84. Therefore, the first air derived from the bleed air from the combustor casing 20 and the second air, which is the compressed air generated by the external compressor 84, can be selectively supplied as the purge air to the oil nozzle 104 by using the second purge-air line 82. In addition, the gas turbine device 1 according to some embodiments can be relatively easily obtained by additionally installing the first purge-air line 74 in the existing gas turbine device 1 including the second purge-air line 82.

In some embodiments, for example, as shown in FIG. 4, the gas turbine device 1 may include a control device 100 (control unit) for controlling opening and closing of the first valve 76 and the second valve 88.

In this case, since the opening and closing of the first valve 76 and the second valve 88 can be controlled by the control device 100 (control unit), the first air from the first purge-air line 74 and the second air from the second purge-air line 82 can be selectively supplied as the purge air to the oil nozzle 104 by appropriately controlling the opening and closing of the first valve 76 and the second valve 88 by the control unit. Therefore, the control device 100 appropriately switches a supply source of the purge air between the first purge-air line 74 and the second purge-air line 82, so that it is possible to effectively suppress damage to the gas turbine components while reducing maintenance costs.

The control device 100 may be configured to receive a signal indicating an operation state of the gas turbine device 1 from, for example, a higher-level control device. The control device 100 may be configured to control opening and closing of the first valve 76 and the second valve 88 based on the signal indicating the operation state of the gas turbine device 1.

The control device 100 (control unit) includes a computer including a processor (CPU or the like), a main storage device (memory device; RAM or the like), an auxiliary storage device, an interface, and the like. The control device 100 is configured to receive a signal from a higher-level control device or a pressure sensor 98 (to be described later) via an interface. The processor is configured to process the received signals. In addition, the processor is configured to process a program deployed in the main storage device. Accordingly, the function of the control device 100 is realized.

As shown in FIG. 4, in the second purge-air line 82, the pressure sensor 98 for detecting the pressure of the second purge-air line 82 may be provided downstream of the pressure-regulating valve 90. A signal indicating a pressure measurement value by the pressure sensor 98 is sent to the control device 100. The control device 100 may be configured to adjust the opening degree of the pressure-regulating valve 90 such that the purge air having an appropriate pressure is supplied to the oil nozzle 104, based on the pressure measurement value acquired by the pressure sensor 98.

### Method for Operating Gas Turbine Device

Hereinafter, a method for operating the gas turbine device 1 according to some embodiments will be described. Hereinafter, the method for operating the gas turbine device 1 (refer to FIGS. 1 to 4) described above will be described. The method for operating described below may be performed using the control device 100 described above, or may be performed manually.

The method for operating the gas turbine device 1 according to some embodiments includes a step of selectively supplying the first air (air derived from the bleed air) from the first purge-air line 74 and the second air (air compressed by the external compressor 84) from the second purge-air line 82 as the purge air to the oil nozzle 104.

In the method according to the above-described embodiment, the first air derived from the bleed air from the combustor casing 20 and the second air, which is the compressed air generated by the external compressor 84, can be selectively supplied as the purge air for suppressing the burn damage of the oil nozzle 104 or for blowing off the remaining oil of the oil nozzle 104. Here, a positive-displacement compressor having a high compression ratio is usually used as the external compressor 84. That is, in the method according to the above-described embodiment, when the first air derived from the bleed air from the combustor casing 20 can be used as the purge air to the oil nozzle 104, the first air is supplied instead of the second air generated by the external compressor 84. Accordingly, the frequency of use of the external compressor 84 can be reduced when the purge air is supplied to the oil nozzle 104. Therefore, the failure rate of the gas turbine components can be reduced. Therefore, according to the method of the above-described embodiment, it is possible to effectively suppress damage to the gas turbine components while reducing maintenance costs.

In one embodiment, during the gas firing operation of the gas turbine device 1 in which the gaseous fuel injected from the gas nozzle 102 is combusted in the combustor 4, the first air from the first purge-air line 74 is supplied to the oil nozzle 104 as the purge air.

During the gas firing operation, the compressed air is generated by the gas turbine compressor 2, so that the air derived from the bleed air (compressed air) from the combustor casing 20 can be used as the purge air of the oil nozzle 104. In this regard, in the above-described embodiment, during the gas firing operation, the first air from the first purge-air line 74 is supplied to the oil nozzle 104 as the purge air. Accordingly, it is possible to suppress damage to the oil nozzle due to intake of the combustion gas during the gas firing operation. During this period, since the second air from the second purge-air line 82 is not required to be used as the purge air of the oil nozzle 104, the frequency of use of the external compressor 84 (compressor for generating the second air) during the operation of the gas turbine device 1 can be significantly reduced. Therefore, the failure rate of the gas turbine components can be reduced. Therefore, according to the above-described method, it is possible to effectively suppress damage to the gas turbine components while reducing maintenance costs.

In one embodiment, during a gas firing operation of the gas turbine device 1 in which the gaseous fuel injected from the gas nozzle 102 is combusted in the combustor 4, at least from a point in time when a rotation speed of the gas turbine device 1 increases and reaches a rated rotation speed to a point in time when combustion in the combustor 4 is extinguished at a time of shutdown of the gas turbine device 1, the first air delivered through the first purge-air line 74 is supplied to the oil nozzle 104 as purge air.

In a gas turbine device of dual-fuel firing, a ratio of time for performing the gas firing operation is larger than that for performing the oil firing operation. In this regard, in the above-described embodiment, the first air from the first purge-air line 74 is supplied to the oil nozzle 104 as the purge air for a majority of the period during the gas firing operation. In this manner, it is possible to suppress damage to the oil nozzle due to intake of the combustion gas during the gas firing operation. During this period, since the second air from the second purge-air line 82 is not required to be used as the purge air of the oil nozzle 104, the frequency of use of the external compressor 84 (compressor for generating the second air) during the operation of the gas turbine device 1 can be significantly reduced. Therefore, the failure rate of the gas turbine components can be reduced. Therefore, according to the above-described method, it is possible to effectively suppress damage to the gas turbine components while reducing maintenance costs.

In one embodiment, when the oil firing operation of the gas turbine device 1 in which the oil fuel injected from the oil nozzle 104 is combusted is switched to the above-described gas firing operation, the second air from the second purge-air line 82 is supplied to the oil nozzle 104 as the purge air.

In the dual-fuel firing gas turbine device 1, there is a case where the fuel is switched between the gaseous fuel and the oil fuel for operation. When the operation of the gas turbine device 1 is switched from the oil firing operation to the gas firing operation, the supply of the fuel oil to the oil nozzle 104 is stopped. However, at this time, a small amount of the fuel oil remains in the oil nozzle 104. In this regard, according to the method of the above-described embodiment, when the operation of the gas turbine device 1 is switched from the oil firing operation to the gas firing operation, the high-pressure second air compressed by the external compressor 84 is supplied to the oil nozzle 104 as the purge air. Therefore, a residual oil in the oil nozzle 104 can be appropriately blown off while the oil nozzle 104 is purged with air. Accordingly, damage to the oil nozzle 104 due to intake of the combustion gas or the like can be suppressed, and coking of the residual oil in the oil nozzle 104 can be suppressed. Therefore, according to the above-described method, it is possible to effectively suppress damage to the gas turbine components while reducing maintenance costs.

In one embodiment, after the operation is switched from the oil firing operation to the gas firing operation as described above, during the gas firing operation of the gas turbine device 1, the supply of the second air from the second purge-air line 82 to the oil nozzle 104 is stopped, and the supply of the first air from the first purge-air line 74 to the oil nozzle 104 is started.

In the above-described embodiment, after the operation of the gas turbine device 1 is switched from the oil firing operation to the gas firing operation, the supply of the second air as the purge air to the oil nozzle 104 is stopped, and the supply of the first air to the oil nozzle 104 is started during the gas firing operation. Accordingly, when it is necessary to blow off the residual oil of the oil nozzle 104 (that is, immediately after the end of the oil firing operation), the second air is supplied as the purge air, and when it is no longer necessary, the supply of the second air as the purge air is stopped and the supply of the first air is started. In this manner, the frequency of use of the external compressor 84 (compressor for generating the second air) during the operation of the gas turbine device 1 can be reduced. Therefore, the failure rate of the gas turbine components can be reduced. Therefore, according to the above-described method, it is possible to effectively suppress damage to the gas turbine components while reducing maintenance costs.

In one embodiment, during a period from the oil firing operation of the gas turbine device 1 to the stop of the gas turbine device 1, for example, during at least a part of a period until the rotation speed of the gas turbine device 1 becomes zero from the rated rotation speed, the second air from the second purge-air line 82 is supplied to the oil nozzle 104 as the purge air.

When the operation of the gas turbine device 1 during the oil firing operation is stopped, the supply of the fuel oil to the oil nozzle 104 is stopped. However, at this time, a small amount of the fuel oil remains in the oil nozzle 104. In this regard, according to the method of the above-described embodiment, within a period until the gas turbine device 1 during the oil firing operation stops, the high-pressure second air compressed by the external compressor 84 is supplied to the oil nozzle 104 as the purge air. Therefore, the residual oil in the oil nozzle 104 can be appropriately blown off while the oil nozzle 104 is purged with air. Accordingly, damage to the oil nozzle 104 due to intake of the combustion gas or the like can be suppressed, and coking of the residual oil in the oil nozzle 104 can be suppressed. Therefore, according to the above-described method, it is possible to effectively suppress damage to the gas turbine components while reducing maintenance costs.

For example, contents described in each of the above-described embodiments are understood as follows.

(1) A gas turbine device (1) according to at least one embodiment of the present invention includes:
a combustor casing (20) to which compressed air from a gas turbine compressor (2) is guided;
a combustor (4) provided in the combustor casing and including a gas nozzle (102) for injecting a gaseous fuel and an oil nozzle (104) for ejecting an oil fuel;
a first purge-air line (74) configured to supply first air derived from bleed air from the combustor casing to the oil nozzle; and
a second purge-air line (82) configured to supply second air compressed by an external compressor (84) different from the gas turbine compressor to the oil nozzle,
in which the gas turbine device is configured to selectively supply either the first air from the first purge-air line or the second air from the second purge-air line to the oil nozzle as purge air.

In the configuration of (1) above, the first air derived from the bleed air from the combustor casing and the second air, which is the compressed air generated by the external compressor, can be selectively supplied as the purge air for suppressing the burn damage of the oil nozzle or for blowing off the remaining oil of the oil nozzle. Here, a positive-displacement compressor having a high compression ratio is usually used as the external compressor. That is, in the configuration of (1) above, when the first air derived from the bleed air from the combustor casing can be used as the purge air to the oil nozzle, the first air is supplied instead of the second air generated by the external compressor, so that the frequency of use of the external compressor can be reduced when the purge air is supplied to the oil nozzle. Therefore, the failure rate of the gas turbine components can be reduced. Therefore, according to the configuration of (1) above, it is possible to effectively suppress damage to the gas turbine components while reducing maintenance costs.

(2) In some embodiments, in the configuration of (1) above,
the gas turbine device includes:
a first valve (76) provided in the first purge-air line and capable of switching a supply state of the first air from the first purge-air line to the oil nozzle; and
a second valve (88) provided in the second purge-air line and capable of switching a supply state of the second air from the second purge-air line to the oil nozzle.

According to the configuration of (2) above, since the first valve and the second valve are respectively provided in the first purge-air line and the second purge-air line, the first air from the first purge-air line and the second air from the second purge-air line can be selectively supplied as the purge air to the oil nozzle by appropriately opening and closing the valves. Therefore, as described in (1) above, it is possible to effectively suppress damage to the gas turbine components while reducing maintenance costs.

(2′) In some embodiments, in the configuration of (2) above, the gas turbine device includes a control unit (for example, the control device 100 described above) for controlling opening and closing of the first valve and the second valve.

According to the configuration of (2′) above, since the opening and closing of the first valve and the second valve can be controlled by the control unit, the first air from the first purge-air line and the second air from the second purge-air line can be selectively supplied as the purge air to the oil nozzle by appropriately controlling the opening and closing of the first valve and the second valve by the control unit. Therefore, as described in (1) above, it is possible to effectively suppress damage to the gas turbine components while reducing maintenance costs.

(3) In some embodiments, in the configuration of (1) or (2) above,
the oil nozzle (for example, the first fuel nozzle 40 described above) is provided to extend along a central axis of a combustor liner of the combustor.

The oil nozzle (for example, the pilot nozzle (the first fuel nozzle 40) or the like) provided to extend along the central axis of the combustor liner is located near a region where the fuel is combusted, compared to the nozzle (for example, the second fuel nozzle 46 described above) disposed in the vicinity of the oil nozzle. Therefore, there is a high risk of burn damage due to intake of high-temperature combustion gas. Therefore, it is highly necessary to supply the high-pressure purge air to the oil nozzle. In this regard, according to the configuration of (3) above, the first air derived from the bleed air from the combustor casing and the second air, which is the compressed air generated by the external compressor, can be selectively supplied as the purge air to the oil nozzle provided to extend along the central axis of the combustor liner. Therefore, it is possible to more effectively suppress damage to the gas turbine components while reducing maintenance costs.

(4) In some embodiments, in the configuration of any one of (1) to (3) above,
the gas turbine device includes:
a bleed-air compressor (68) for boosting the bleed air from the combustor casing,
in which the first purge-air line is configured to supply the first air generated by compressing the bleed air with the bleed-air compressor to the oil nozzle.

According to the configuration of (4) above, the bleed air (air compressed by the gas turbine compressor) from the combustor casing is further boosted by the bleed-air compressor. Therefore, the first air having a pressure (pressure higher than the pressure of the combustor casing) appropriate for the purge air for suppressing the combustion gas intake of the oil nozzle can be generated. Therefore, when the first air derived from the bleed air from the combustor casing can be used as the purge air (for example, when the combustor casing pressure is a predetermined value or higher), the first air can be supplied as the purge air. Therefore, the frequency of use of the external compressor when the purge air is supplied to the oil nozzle can be reduced. Therefore, the failure rate of the gas turbine components can be reduced. Therefore, according to the configuration of (4) above, it is possible to effectively suppress damage to the gas turbine components while reducing maintenance costs.

(5) In some embodiments, in the configuration of (4) above,
the external compressor includes a positive-displacement compressor, and
the bleed-air compressor includes a turbo compressor.

According to the configuration of (5) above, the positive-displacement compressor having a relatively high pressure ratio compared to a turbo compressor or the like is used as the external compressor, and the turbo compressor having a lower failure rate than the positive-displacement compressor in general is used as the bleed-air compressor. Therefore, when the first air derived from the bleed air from the combustor casing can be used as the purge air, the first air compressed by the bleed-air compressor (turbo compressor) is supplied as the purge air, so that the failure rate of the gas turbine components can be effectively reduced. Therefore, according to the configuration of (5) above, it is possible to effectively suppress damage to the gas turbine components while effectively reducing maintenance costs.

(6) In some embodiments, in the configuration of any one of (1) to (5) above,
the gas turbine device includes:
a bleed-air line (for example, the second bleed-air line 60 described above) configured to supply the bleed air from the combustor casing as cooling air to a stationary part of the gas turbine device,
in which the first purge-air line branches from the bleed-air line.

In order to supply the bleed air, as cooling air, from the combustor casing to a stationary member such as a combustor to which a high-pressure gas (high-pressure air or combustion gas) is supplied, a compressor (bleed-air compressor) for making the bleed air have a pressure higher than the pressure of the combustor casing is required. In the configuration of (6) above, the first purge-air line branches from the bleed-air line for supplying the bleed air from the combustor casing to a stationary part such as the combustor as the cooling air. Therefore, the air derived from the bleed air led from the bleed-air line to the first purge-air line is supplied to the oil nozzle as the purge air. Therefore, the bleed-air line can be used for both the supply of the cooling air and the supply of the purge air to the oil nozzle, and the installation area of the equipment can be reduced as compared with a case where the bleed-air line for the purge air is installed separately from the bleed-air line for the cooling air.

(7) In some embodiments, in the configuration of any one of (1) to (6) above, the gas turbine device includes: at least one cooler (for example, any one of a first bleed-air cooler 64, a second bleed-air cooler 66, or a purge-air cooler 78) for cooling the first air derived from the bleed air.

According to the configuration of (7) above, the first air derived from the bleed air can be cooled by the cooler. Therefore, the air derived from the bleed air can be easily cooled to a temperature suitable for the purge air to be supplied to the oil nozzle.

(8) In some embodiments, in the configuration of (7) above, the at least one cooler includes a plurality of coolers.

According to the configuration of (8) above, the first air derived from the bleed air can be cooled by the plurality of coolers. Therefore, the air derived from the bleed air is more likely to be cooled to a temperature suitable for the purge air to be supplied to the oil nozzle.

(8′) In some embodiments, in the configuration of (7) or (8) above,
the gas turbine device includes:
a cooler (for example, the purge-air cooler 78 described above) provided in the first purge-air line and cooling the first air derived from the bleed air.

According to the configuration of (8′) above, the air that has flowed into the first purge-air line from the bleed-air line through which the cooling air for cooling the stationary member such as the combustor flows can be further cooled by the cooler provided in the first purge-air line. Therefore, by supplying the first air cooled in this way to the oil nozzle as the purge air, it is possible to more effectively suppress the burn damage of the oil nozzle due to the high-temperature combustion gas intake or the like.

(9) In some embodiments, in the configuration of any one of (1) to (8) above,
a downstream end of the first purge-air line is connected to the second purge-air line downstream of the external compressor.

According to the configuration of (9) above, the downstream end of the first purge-air line is connected to the second purge-air line downstream of the external compressor. Therefore, the first air derived from the bleed air from the combustor casing and the second air, which is the compressed air generated by the external compressor, can be selectively supplied as the purge air to the oil nozzle by using the second purge-air line. In addition, the gas turbine device having the configuration of (9) can be relatively easily obtained by additionally installing the first purge-air line in the existing gas turbine device including the second purge-air line.

(10) A method for operating a gas turbine device including a combustor casing (20) to which compressed air from a gas turbine compressor (2) is guided, a combustor provided in the combustor casing and including a gas nozzle (102) for injecting a gaseous fuel and an oil nozzle (104) for ejecting an oil fuel, a first purge-air line (74) configured to supply first air derived from bleed air from the combustor casing to the oil nozzle, and a second purge-air line (82) configured to supply second air compressed by an external compressor different from the gas turbine compressor to the oil nozzle, the method including:
a step of selectively supplying either the first air from the first purge-air line or the second air from the second purge-air line to the oil nozzle as purge air.

In the method of (10) above, the first air derived from the bleed air from the combustor casing and the second air, which is the compressed air generated by the external compressor, can be selectively supplied as purge air for suppressing the burn damage of the oil nozzle or for blowing off the remaining oil of the oil nozzle. Here, a positive-displacement compressor having a high compression ratio is usually used as the external compressor. That is, in the method of (10) above, when the first air derived from the bleed air from the combustor casing can be used as the purge air to the oil nozzle, the first air is supplied instead of the second air generated by the external compressor. Accordingly, the frequency of use of the external compressor can be reduced when the purge air is supplied to the oil nozzle. Therefore, the failure rate of the gas turbine components can be reduced. Therefore, according to the method of (10) above, it is possible to effectively suppress damage to the gas turbine components while reducing maintenance costs.

(11) In some embodiments, in the method of (10) above,
during a gas firing operation of the gas turbine device in which the gaseous fuel injected from the gas nozzle is combusted, the first air from the first purge-air line is supplied to the oil nozzle as the purge air.

During the gas firing operation, the compressed air is generated by the gas turbine compressor, so that the air derived from the bleed air (compressed air) from the combustor casing can be used as the purge air of the oil nozzle. According to the method of (11) above, during the gas firing operation, the first air from the first purge-air line is supplied to the oil nozzle as the purge air. Accordingly, it is possible to suppress damage to the oil nozzle caused by intake of the combustion gas during the gas firing operation. During this period, since the second air from the second purge-air line is not required to be used as the purge air of the oil nozzle, the frequency of use of the external compressor (compressor for generating the second air) during the operation of the gas turbine device can be significantly reduced. Therefore, the failure rate of the gas turbine components can be reduced. Therefore, according to the method of (11) above, it is possible to effectively suppress damage to the gas turbine components while reducing maintenance costs.

(12) In some embodiments, in the configuration of (10) or (11) above,
during a gas firing operation of the gas turbine device in which the gaseous fuel injected from the gas nozzle is combusted, at least from a point in time when a rotation speed of the gas turbine device increases and reaches a rated rotation speed to a point in time when combustion in the combustor is extinguished at a time of shutdown of the gas turbine device, the first air delivered through the first purge-air line is supplied to the oil nozzle as the purge air.

In a gas turbine device of dual-fuel firing, a ratio of time for performing the gas firing operation is larger than that for performing the oil firing operation. In this regard, in the method of (12) above, during most of the period of the gas firing operation, the first air from the first purge-air line is supplied to the oil nozzle as the purge air. Accordingly, it is possible to suppress damage to the oil nozzle due to intake of the combustion gas or the like during the gas firing operation. During this period, since the second air from the second purge-air line is not required to be used as the purge air of the oil nozzle, the frequency of use of the external compressor (compressor for generating the second air) during the operation of the gas turbine device can be significantly reduced. Therefore, the failure rate of the gas turbine components can be reduced. Therefore, according to the above-described method, it is possible to effectively suppress damage to the gas turbine components while reducing maintenance costs.

(13) In some embodiments, in the method of any one of (10) to (12) above,
when switching from an oil firing operation of the gas turbine device in which the oil fuel injected from the oil nozzle is combusted to a gas firing operation of the gas turbine device in which the gaseous fuel injected from the gas nozzle is combusted, the second air from the second purge-air line is supplied to the oil nozzle as the purge air.

When the operation of the gas turbine device is switched from the oil firing operation to the gas firing operation, the supply of the fuel oil to the oil nozzle is stopped. However, at this time, a small amount of the fuel oil remains in the oil nozzle. In this regard, according to the method of (13) above, when the operation of the gas turbine device is switched from the oil firing operation to the gas firing operation, the high-pressure second air compressed by the external compressor is supplied to the oil nozzle as the purge air. Therefore, the residual oil in the oil nozzle can be appropriately blown off while the oil nozzle is purged with air. Accordingly, damage to the oil nozzle due to intake of the combustion gas and the like can be suppressed, and coking of the residual oil in the oil nozzle can be suppressed. Therefore, according to the method of (13) above, it is possible to effectively suppress damage to the gas turbine components while reducing maintenance costs.

(14) In some embodiments, in the method of (13) above,
during the gas firing operation after the switching from the oil firing operation to the gas firing operation of the gas turbine device, the supply of the second air from the second purge-air line to the oil nozzle is stopped and the supply of the first air from the first purge-air line to the oil nozzle is started.

According to the method of (14) above, during the gas firing operation after the operation of the gas turbine device is switched from the oil firing operation to the gas firing operation, the supply of the second air as the purge air to the oil nozzle is stopped, and the supply of the first air to the oil nozzle is started. In this way, when it is necessary to blow off the residual oil of the oil nozzle, the second air is supplied as the purge air, and when it is no longer necessary to blow off the residual oil, the supply of the second air as the purge air is stopped and the supply of the first air is started. Accordingly, the frequency of use of the external compressor (compressor for generating the second air) during the operation of the gas turbine device can be reduced. Therefore, the failure rate of the gas turbine components can be reduced. Therefore, according to the method of (14) above, it is possible to effectively suppress damage to the gas turbine components while reducing maintenance costs.

(15) In some embodiments, in the method of any one of (10) to (14) above,
during a period from an oil firing operation of the gas turbine device in which the oil fuel injected from the oil nozzle is combusted to shutdown of the gas turbine device, the second air from the second purge-air line is supplied to the oil nozzle as the purge air.

When the operation of the gas turbine device during the oil firing operation is stopped, the supply of the fuel oil to the oil nozzle is stopped. However, at this time, a small amount of the fuel oil remains in the oil nozzle. In this regard, according to the method of (15) above, within a period until the gas turbine device during the oil firing operation stops, the high-pressure second air compressed by the external compressor is supplied to the oil nozzle as the purge air. Therefore, the residual oil in the oil nozzle can be appropriately blown off while the oil nozzle is purged with air. Accordingly, damage to the oil nozzle due to intake of the combustion gas and the like can be suppressed, and coking of the residual oil in the oil nozzle can be suppressed. Therefore, according to the method of (15) above, it is possible to effectively suppress damage to the gas turbine components while reducing maintenance costs.

Although the embodiments of the present invention have been described, the present invention is not limited to the above-described embodiments, and includes modifications of the above-described embodiments and a combination of these embodiments as appropriate.

In the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For example, expressions representing that things are in an equal state such as “same”, “equal”, and “homogeneous” not only strictly represent an equal state, but also represent a state where a difference exists with a tolerance or to such an extent that the same function can be obtained.

Further, for instance, an expression of a shape such as a rectangular shape or a cylindrical shape shall not be construed as only the geometrically strict shape, but also includes a shape with unevenness or chamfered corners within the range in which the same effect can be achieved.

Further, in the present specification, expressions such as “being provided with”, “including”, and “having” one component are not exclusive expressions excluding the presence of other components.

### REFERENCE SIGNS LIST

1: gas turbine device
2: gas turbine compressor
4: combustor
6: turbine
8: rotor
10: compressor casing
12: air intake port
16: stator vane
18: rotor blade
20: combustor casing
22: turbine casing
24: stator vane
26: rotor blade
28: combustion gas passage
30: exhaust chamber
38: first combustion burner
40: first fuel nozzle
40a: gaseous fuel ejecting hole
40b: oil fuel ejecting hole
41: first burner cylinder
42: first fuel port
43: second fuel port
44: second combustion burner
45: swirler
46: second fuel nozzle
46a: gaseous fuel ejecting hole
46b: oil fuel ejecting hole
47: second burner cylinder
48: inner cylinder
49: swirler
50: combustor liner
52: outer cylinder
54: air passage
60: second bleed-air line
62: first bleed-air line
63: booster
64: first bleed-air cooler
66: second bleed-air cooler
67: valve
68: bleed-air compressor
70: filter
74: first purge-air line
76: first valve
78: purge-air cooler
80: filter
82: second purge-air line
84, 84A, 84B: external compressor
86: air receiver
88: second valve
90: pressure-regulating valve
92: second purge-air line
98: pressure sensor
100: control device
102: gas nozzle
104: oil nozzle
106: gaseous fuel passage
108: oil fuel passage
110: gaseous fuel passage
112: oil fuel passage
O: rotor axis
Q: central axis

1-15. (canceled)

16. A gas turbine device comprising:
a combustor casing to which compressed air from a gas turbine compressor is guided;
a combustor provided in the combustor casing and including a gas nozzle for injecting a gaseous fuel and an oil nozzle for ejecting an oil fuel;
a first purge-air line configured to supply first air derived from bleed air from the combustor casing to the oil nozzle; and
a second purge-air line configured to supply second air compressed by an external compressor different from the gas turbine compressor to the oil nozzle,
wherein the gas turbine device is configured to selectively supply either the first air from the first purge-air line or the second air from the second purge-air line to the oil nozzle as purge air,
wherein the gas turbine device further comprises a bleed-air line configured to supply the bleed air from the combustor casing as cooling air to a stationary member of the gas turbine device, and
wherein the first purge-air line branches from the bleed-air line.

17. The gas turbine device according to claim 16, further comprising:
a first valve provided in the first purge-air line and capable of switching a supply state of the first air from the first purge-air line to the oil nozzle; and
a second valve provided in the second purge-air line and capable of switching a supply state of the second air from the second purge-air line to the oil nozzle.

18. The gas turbine device according to claim 16,
wherein the oil nozzle is provided to extend along a central axis of a combustor liner of the combustor.

19. The gas turbine device according to claim 16, further comprising:
a bleed-air compressor for boosting the bleed air from the combustor casing,
wherein the first purge-air line is configured to supply the first air generated by compressing the bleed air with the bleed-air compressor to the oil nozzle.

20. The gas turbine device according to claim 19,
wherein the external compressor includes a positive-displacement compressor, and the bleed-air compressor includes a turbo compressor.

21. The gas turbine device according to claim 16, further comprising:
at least one cooler for cooling the first air derived from the bleed air.

22. The gas turbine device according to claim 21,
wherein the at least one cooler includes a plurality of coolers.

23. The gas turbine device according to claim 16,
wherein a downstream end of the first purge-air line is connected to the second purge-air line downstream of the external compressor.

24. The gas turbine device according to claim 16, further comprising:
a cooler provided in the first purge-air line for cooling the first air derived from the bleed air.

25. The gas turbine device according to claim 16,
wherein the bleed-air line includes:
a first bleed-air line configured to supply the bleed air from the combustor casing as cooling air to a rotating member of the gas turbine device; and
a second bleed-air line provided to branch from the first bleed-air line and configured to supply the air from the first bleed-air line as cooling air to a stationary member of the gas turbine device.

26. The gas turbine device according to claim 25, further comprising:
a first bleed-air cooler provided in the first bleed-air line; and
a second bleed-air cooler provided in the second bleed-air line,
wherein the second bleed-air line is provided to branch from the first bleed-air line downstream of the first bleed-air cooler, and
wherein the first purge-air line is provided to branch from the second bleed-air line downstream of the second bleed-air cooler.

27. The gas turbine device according to claim 25, further comprising:
a booster, provided in the first bleed-air line, for boosting the pressure of the cooling air; and
a bleed-air compressor provided in the second bleed-air line upstream of a branching point of the first purge-air line,
wherein the pressure at an outlet of the bleed-air compressor in the second bleed-air line is higher than the pressure at an outlet of the booster in the first bleed-air line.

28. A method for operating a gas turbine device including a combustor casing to which compressed air from a gas turbine compressor is guided, a combustor provided in the combustor casing and including a gas nozzle for injecting a gaseous fuel and an oil nozzle for ejecting an oil fuel, a first purge-air line configured to supply first air derived from bleed air from the combustor casing to the oil nozzle, and a second purge-air line configured to supply second air compressed by an external compressor different from the gas turbine compressor to the oil nozzle, and a bleed-air line configured to supply the bleed air from the combustor casing as cooling air to a stationary member of the gas turbine device, the first purge-air line branching from the bleed-air line, the method comprising:
a step of selectively supplying either the first air from the first purge-air line or the second air from the second purge-air line to the oil nozzle as purge air.

29. The method for operating a gas turbine device according to claim 28,
wherein during a gas firing operation of the gas turbine device in which the gaseous fuel injected from the gas nozzle is combusted, the first air from the first purge-air line is supplied to the oil nozzle as the purge air.

30. The method for operating a gas turbine device according to claim 28,
wherein during a gas firing operation of the gas turbine device in which the gaseous fuel injected from the gas nozzle is combusted, at least from a point in time when a rotation speed of the gas turbine device increases and reaches a rated rotation speed to a point in time when combustion in the combustor is extinguished at a time of shutdown of the gas turbine device, the first air delivered through the first purge-air line is supplied to the oil nozzle as the purge air.

31. The method for operating a gas turbine device according to claim 28,
wherein when switching from an oil firing operation of the gas turbine device in which the oil fuel injected from the oil nozzle is combusted to a gas firing operation of the gas turbine device in which the gaseous fuel injected from the gas nozzle is combusted, the second air from the second purge-air line is supplied to the oil nozzle as the purge air.

32. The method for operating a gas turbine device according to claim 28,
wherein during a period from an oil firing operation of the gas turbine device in which the oil fuel injected from the oil nozzle is combusted to shutdown of the gas turbine device, the second air from the second purge-air line is supplied to the oil nozzle as the purge air.

33. A method for operating a gas turbine device including a combustor casing to which compressed air from a gas turbine compressor is guided, a combustor provided in the combustor casing and including a gas nozzle for injecting a gaseous fuel and an oil nozzle for ejecting an oil fuel, a first purge-air line configured to supply first air derived from bleed air from the combustor casing to the oil nozzle, and a second purge-air line configured to supply second air compressed by an external compressor different from the gas turbine compressor to the oil nozzle, the method comprising:
a step of selectively supplying either the first air from the first purge-air line or the second air from the second purge-air line to the oil nozzle as purge air,
wherein when switching from an oil firing operation of the gas turbine device in which the oil fuel injected from the oil nozzle is combusted to a gas firing operation of the gas turbine device in which the gaseous fuel injected from the gas nozzle is combusted, the second air from the second purge-air line is supplied to the oil nozzle as the purge air, and
wherein during the gas firing operation after the switching from the oil firing operation to the gas firing operation of the gas turbine device, the supply of the second air from the second purge-air line to the oil nozzle is stopped and the supply of the first air from the first purge-air line to the oil nozzle is started.
